(19) United States
(12) Patent Application Publication
(10) Pub. No.: US 2006/0143439 A1
(43) Pub. Date: Jun. 29, 2006

(54) Method and system for sensor data management

(75) Inventors: Murugan Arumugam, Fremont, CA (US); Chellappa Dhanukodi, Milpitas, CA (US); Kanth Krishnan, Fremont, CA (US)

Correspondence Address: GREENBERG TRAURIG, LLP, 1900 UNIVERSITY AVENUE, FIFTH FLOOR, EAST PALO ALTO, CA, 94303, US

(73) Assignee: Xpaseo

(21) Appl. No.: 11/295,880

(22) Filed: Dec. 6, 2005

Related U.S. Application Data
(60) Provisional application No. 60/633,845, filed on Dec. 6, 2004.

(51) Int. Cl. H04L 9/00; H04Q 5/22; G06F 17/00; G08B 13/14

(52) U.S. Cl. 713/153; 713/154; 340/572.1; 340/10.1; 235/375

(57) ABSTRACT

Methods and systems for real-time management of sensor data, based on application level logic made available at the edge of the enterprise are disclosed. According to an embodiment of the invention, an intelligent data router is communicatively coupled to one or more data sensors and a data management server. In one embodiment, the intelligent data router executes application level logic encapsulating business rules to make real-time enterprise data decisions and execute business transactions.

### RELATED APPLICATIONS

This application claims the benefit of U.S. Provisional Application No. 60/633,845, filed Dec. 6, 2004, which is hereby incorporated herein by reference.

### FIELD OF THE INVENTION

The present invention relates generally to sensor networks. More particularly, the present invention relates to methods and systems for real-time management of sensor data, based on application level logic made available at the edge of the network.

### BACKGROUND OF THE INVENTION

A sensor network is a network of many, spatially distributed devices that use sensors to monitor conditions at one or more locations. Although sensor networks may be used in a great number of applications and settings, sensor networks, and radio frequency identification (RFID) systems in particular, have been increasingly used in applications for managing supply chains. The number and variety of RFID systems, as well as solutions and applications based on RFID systems, has been rapidly increasing as RFID-related technologies mature. As illustrated in FIG. 1, a typical RFID system 10 includes a server 12 and a storage device 14 to store identifying data received from a network of RFID readers 16. Each RFID reader 16 in the RFID reader network is strategically placed to sense RFID tags 18 attached to objects 20 when the objects are within a predetermined proximity of the RFID reader 16.

Existing RFID systems tend to generate extremely large amounts of data in a very short amount of time—particularly RFID systems utilized in real-time applications. For example, a network of RFID readers used for tracking inventory in a large distribution center may generate several terabytes of data per day. Moreover, it is not uncommon for data on servers in a variety of locations to be forwarded to a “master” server at a centralized location. Consequently, the large amount of data generated by RFID readers can have a significant negative impact on network bandwidth and sever load. In some cases, significant inefficiencies exist because the “master” server filters and discards large amounts of unnecessary or unneeded data that it receives.

Another primary problem with existing RFID systems is that they do not easily adapt to increased demands—that is, the systems are not very scaleable. Scalability is important because it allows an enterprise to invest in a system with confidence that it will not outgrow it. With current RFID systems, when the amount of data becomes so large that server performance becomes an issue, often the only option is to add another server at considerable expense. Furthermore, many existing RFID readers use proprietary networking and communication protocols. Consequently, enterprises are often required to deploy a separate RFID network that duplicates all, or portions of, their existing data network. Moreover, proprietary components make it difficult to integrate components (e.g., RFID readers, application software, etc.) from different vendors, thereby forcing enterprises to choose a single solution from one vendor and further increasing the risk of future obsolescence.

Finally, many existing RFID systems are poorly integrated with the business applications that use their data. In some cases, application integration must be achieved on the business application side by complicated data importing procedures. In many cases, application integration only means that an RFID system stores data in a format that can be used by a particular business application. This requires that the particular business application constantly read in the data. Typically, an import operation must be performed before the data is available, making it difficult, if not impossible, to implement real-time solutions. Finally, because business rules are executed and data decisions are made exclusively at the application level, a large amount of data captured by RFID readers is never utilized. The present invention was conceived with these and other problems in mind.

### SUMMARY OF THE DESCRIPTION

Methods and systems for real-time management of sensor data, based on application level logic made available at the edge of the enterprise are disclosed. According to an embodiment of the invention, an intelligent data router is communicatively coupled to an enterprise data management server, an enterprise resource planning (ERP) system, and one or more data sensors. Accordingly, applications executing on the intelligent data router, in real-time, analyze and process sensor data and enterprise data received at the intelligent data router Other aspects of the present invention are described below.

### BRIEF DESCRIPTION OF THE DRAWINGS

The present invention is illustrated by way of example, and not by way of limitation, in the figures of the accompanying drawings, in which like references indicate similar elements, and in which:

FIG. 1 illustrates an example of a prior art RFID system including a network of RFID readers connected to a server with an attached storage device;

FIG. 2 illustrates an example of a data management system, according to an embodiment of the present invention;

FIG. 3 illustrates an intelligent RFID data router according to one embodiment of the invention;

FIG. 4 illustrates an enterprise RFID data management server according to one embodiment of the invention; and

FIGS. 5 and 6 illustrate an example of the type of environment in which one embodiment of the present invention might be deployed.

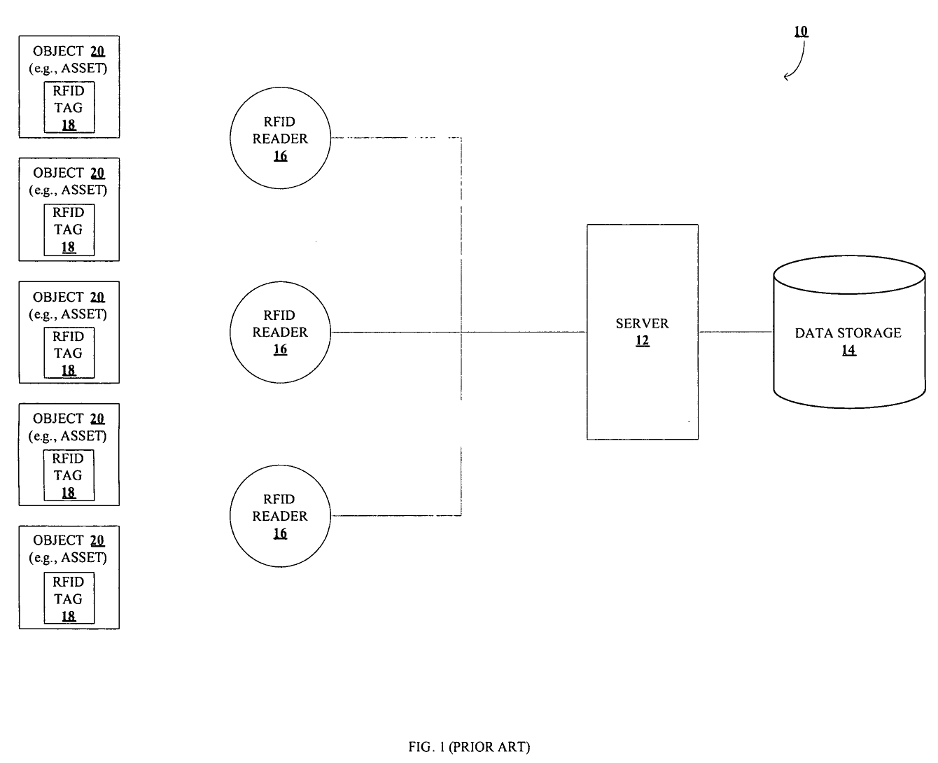

### DETAILED DESCRIPTION

Methods and systems for real-time management of sensor data, based on application level logic made available at the edge of the enterprise are disclosed. In the following description, for purposes of explanation, numerous specific details are set forth in order to provide a thorough understanding of the present invention. It will be evident, however, to one skilled in the art that the present invention may be practiced without these specific details.

According to one aspect of the invention, a system for managing sensor data in real time is disclosed. In one embodiment of the invention, the system may be implemented as a two-layer distributed software application architecture. In this two-layer scheme, the first layer can be thought of as conventional business applications, such as enterprise resource planning (ERP) business applications, which are executed on server or workstation computers. The second layer consists of applications or application level logic which reside on one or more intelligent data routers, and may be associated with the business applications of the ERP system. The intelligent data routers are configured to manage and control data sensors coupled to the data routers. Accordingly, the application level logic executing on the intelligent data routers facilitates the real-time execution of business level transactions utilizing enterprise data and sensor data received via ERP systems and data sensors operating at the network edge.

In one embodiment of the invention, the two-layer software architecture provides support for a wide variety of raw data emanating from existing sensor devices (e.g., temperature sensors, pressure sensors, RFID readers, bar code readers, global positioning system (GPS) devices, etc.). In addition, the system architecture provides a framework to absorb future changes in sensor technology. As will be described in further detail below, the system architecture, which includes application level logic operating at the network edge (e.g. at intelligent data routers), provides a mechanism for configuring, constructing and executing business rules that operate on data generated in real-time. Accordingly, business level decisions are executed in real-time at the point where the data is generated. Moreover, the intelligent data routers executing the application level logic at the network edge provides processing and storage capabilities, which act upon incoming data and transforms it into transactions in real-time.

In one embodiment of the invention, the system architecture facilitates real-time bi-directional flow of enterprise transaction data between the two layers of the system architecture. For example, transaction data from ERP business applications operated by the enterprise or third parties (e.g., trading partners) may be “pushed” or “pulled” in real-time to an intelligent data router at the network edge. The transaction data may be communicated from an ERP system to the intelligent data router in real-time based on demand, or alternatively, the transaction data may reside at the intelligent data router in anticipation of its use for making data decisions. The transaction data thus obtained can be used to configure, construct and execute business rules in real-time. In one embodiment of the invention, application level logic residing at an intelligent data router operates on data received from data sensors and stored at the intelligent data router. In addition, the application level logic may operate on data received from an external source, such as an ERP business application, and stored at the intelligent data router.

In one embodiment of the invention, the system architecture includes application containers that have business applications with capabilities to handle transactions using embedded logic to ensure real-time processing based on enterprise events. For example when sensors connected to an intelligent data router located at or near an inbound dock (e.g., in a warehouse) detect arrival of inventory items from a supplier, an application container relating to goods receipt may facilitate, in real-time, the authentication of the inbound inventory. In addition, one or more application containers may facilitate a wide variety of other processing tasks. For example, exceptions may be raised, alerts may be invoked, or a transaction may be posted in one or more business systems. In contrast to present solutions, this capability is available in an independent distributed fashion in real-time.

In one embodiment of the invention, the intelligent data router includes dynamic, configurable business rules that accept changes in the environment and act upon the events in the enterprise in a real-time fashion. These business rules can be modified in real-time without compiling code or taking any part of the system offline. The uniqueness of this method eliminates the requirement for manual fine-tuning of business rules on an ongoing basis. The rules are generated and executed in real-time using a method of complex event processing. In one embodiment of the invention, an application programming interface facilitates easy integration with third party applications.

It will be appreciated by those skilled in the art that the present invention may be implemented in a variety of form factors, including both software and hardware components. For example, in one embodiment, an intelligent data router is implemented as a network appliance. Accordingly, the network appliance may be rugged in design so as to withstand deployment in warehouses and other similar industrial locations. Alternatively, the intelligent data router may be implemented as part of a chip set, or a controller card. For example, as a controller card, the intelligent data router may be integrated in a large variety of systems, including conventional computers. It will be appreciated by those skilled in the art that the present invention may be implemented in hardware, software, or preferably a combination thereof. Accordingly, portions of the present invention may be implemented as embedded software applications.

In one embodiment of the invention, an intelligent data router includes compression logic. Compression logic is utilized to reduce bandwidth strain. The compression algorithms involve using reduced data sample sizes without losing intrinsic data value. The compression is enabled by optimized data collection and sampling resulting in efficient utilization of bandwidth, processing and storage. The compression algorithms have a built-in ability to pack, store and forward highly concentrated data, which adds to efficiencies in bandwidth and storage issues.

The intelligent data router leverages a memory-resident thin footprint database to enable data storage for various purposes. This storage capability coupled with the processing capabilities described above, represents an improved method of implementing real-time management of enterprise data at the edge. One example of the utility is the filtering of reads from data sensors. Consistent with the present invention, an intelligent data router is better positioned to apply strong processing logic backed by locally available data elements from the database, thereby resulting in much higher throughput relative to processing capabilities. In essence, the intelligent data router processes high volumes of data, closer to the edge, at very low cost of computing. Prior solutions generally rely on processing logic alone and do not include locally accessible databases for business or application level decision making and data filtering. Consequently, prior art systems depend heavily on processing power. In high data volume environments, such as inventory warehouses, systems that depend on processing power alone may be burdened by the high volume of data that is generated.

In one embodiment of the invention, the intelligent data router includes a storage module (e.g., memory, flash memory or disk drive) to facilitate batch or line level storage of application data. The application data may be dynamically retrieved in real-time from ERP business applications, and generally does not depend on an off-line “push” mechanism. The application data may be accessed and used by one or more applications local to the intelligent data router to provide a very efficient real-time framework at the edge of the enterprise. In one embodiment of the invention, the retrieval and storage can be activated either based on ERP data/transaction or based on sensor data/event. For example, when an advance shipping notice is received by an ERP system, the event can trigger retrieval of data by the intelligent data router, utilizing a publish and subscribe methodology based on real-time business events. The advanced shipping notice data may be stored in the intelligent data router and may serve as a processing input when inbound inventory is received that is associated with the advanced shipping notice.

Raw data received from sensor devices may be buffered or stored in the storage module depending on the application context. In environments where there is a relatively low-volume of data generated, but the relevance of the data is high (e.g., tracking and security of assets), raw data may be stored for a longer period of time in order to facilitate audit and security trails. The raw data storage will typically be utilized by the business rules in the intelligent data router to carry out alerts and/or notifications. The raw data storage also assists the application container and custom code infrastructure by allowing post-processing or low-level data warehousing operations.

Raw data (e.g., captured by data sensors) and application data can be packaged into “data cubes” or “data silos” and made available for real-time analysis and processing. In addition, archiving of historical data required for localized processing in the immediate future is made possible in the storage module. The utility of such a framework enables very efficient processing and ensures a smooth and disruption-free operation even in a forced isolated environment. For example a remote storage area or warehouse can continue basic processing at the intelligent data router even though connection to the rest of the enterprise may not be constantly available or is only available in an intermittent fashion.

In one embodiment of the invention, the intelligent data router includes an output module that facilitates the smooth delivery of data in a real-time, lossless format from the edge of the enterprise all the way into ERP systems, as well as intelligence and optimization based applications in the enterprise, and to applications under the control of third parties, such as trading partners. For example, in one embodiment of the invention, application level logic executing at the intelligent data router may result in application data and/or sensor data (e.g., including events and notifications) being communicated from the intelligent data router to one or more third party trading partners. The application data may be formatted or unformatted. The intelligent data router, according to one embodiment, is capable of storing and forwarding data to ensure lossless transmission of critical data/posting of transactions to the enterprise applications in real-time. This implementation is vital to enterprises as they move from manual intervention to automation in most of their critical business processes. Other advantages of the present invention will become apparent from the detailed description that follows.

In the context of the present invention, a data sensor, or sensor device, includes any device that measures some physical attribute within or about its surroundings, and converts the measurement into an electronic signal. For example, an RFID reader is a sensor device that uses radio frequency signals to sense data transmitted from RFID tags. Although many of the examples provided herein refer specifically to RFID readers, embodiments of the present invention may be implemented to work with a wide variety of other sensor devices. For example, in certain embodiments of the invention, supported sensor devices may include (but not necessarily be limited to): temperature sensors, pressure sensors, RFID readers, bar code readers, global positioning system (GPS) devices, etc.

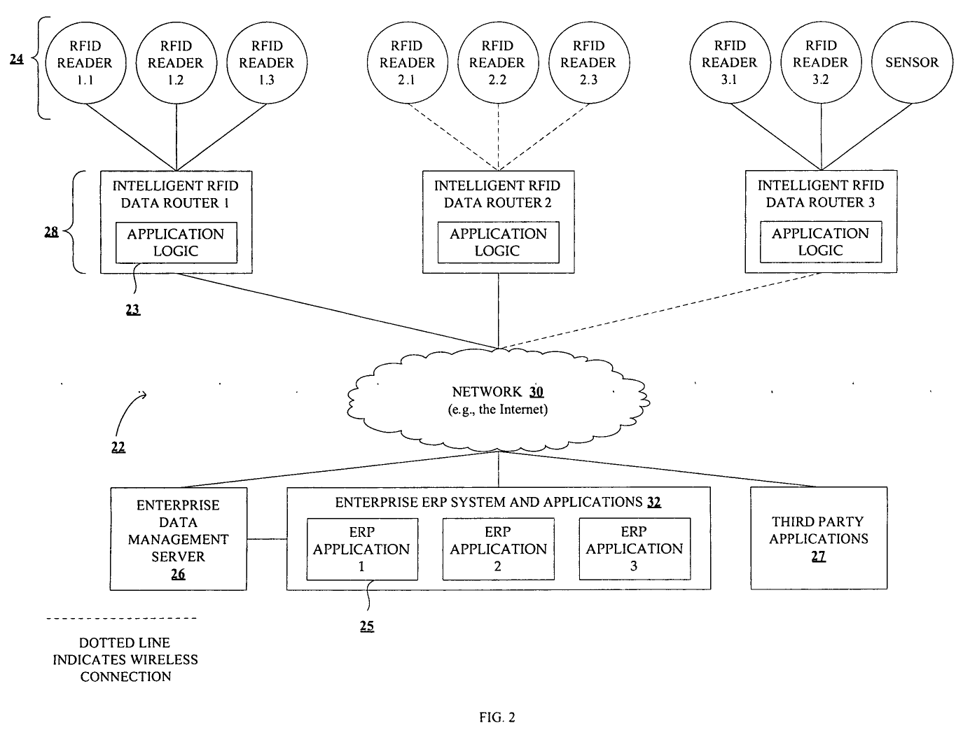

FIG. 2 illustrates an example of a data management system 22, according to an embodiment of the present invention. As illustrated in FIG. 2, the data management system 22 includes a network of RFID readers 24 connected to an enterprise data management server 26 via three intelligent RFID data routers 28. In one embodiment of the invention, the enterprise data management server 26 and each RFID reader 24 may be communicatively coupled over a network 30 to an RFID data router 28 via one or more standard communication protocols and networking protocols. For example, in certain embodiments of the invention, the RFID data router 28 may utilize and/or support communication protocols, such as the transfer control protocol and Internet protocol (TCP/IP) suite, and one or more of the following conventional wire-based or wireless networking protocols that are subject to standards specifications set by the Institute of Electrical and Electronics Engineers (IEEE): Ethernet (IEEE 802.3), wireless local area networks (WLAN) (IEEE 802.11) including wireless fidelity (WiFiTM), and worldwide interoperability for microwave access (WiMax) (IEEE 802.16). Accordingly, the network 30, which may be public (e.g., such as the Internet) and/or private, may include a local area network (LAN), a metropolitan area network (MAN), a wide area network (WAN), or a combination thereof. In certain embodiments of the invention, one or more network nodes may utilize wireless telephony protocols, such as General Packet Radio Service (GPRS) or Code Division Multiple Access (CDMA). In addition, in certain embodiments of the invention, one or more proprietary communication protocols may be supported, particularly to provide support for legacy sensor devices.

Referring again to FIG. 2, in one embodiment of the invention, applications residing on each RFID data router 28 may be remotely configured via the enterprise data management server 26 to analyze and process data received from the RFID readers 24, as well as data received from applications residing on one or more computers that are part of the extended enterprise (e.g., ERP system 32 and third party applications 27). Accordingly, applications residing and executing on the RFID data router may forward sensor data and/or extended enterprise data to an appropriate node of the extended enterprise. As sensor data is captured at one of the RFID readers 24, the sensor data may be communicated to an RFID data router 28. The RFID data router 28 may process the sensor data, in accordance with application level logic embodied in a sensor data processing rule. Accordingly, sensor data may be stored at the RFID data router 28, or alternatively, sensor data may be communicated to an extended enterprise node, including the enterprise data management server 26, or, an ERP application 25, or third party application 27. For example, the RFID data router 28 may analyze the sensor data and route the sensor data directly to an enterprise resource planning (ERP) system 32, another data router, or another software application, depending on the application. In addition, applications at the data router have access to enterprise data stored at the router. Accordingly, an application executing at a data router may process enterprise data in response to receiving particular sensor data.

In one embodiment of the invention, the data processing rules of the application level logic 23 are directly associated with ERP applications 25 residing on an enterprise ERP system 32. Accordingly, the data processing rules may be dependent upon enterprise data. That is, the data processing rules that instruct the RFID data router 28 to process sensor data may be dependent upon enterprise data that is stored either at the RFID data router 28, or alternatively, at another node of the extended enterprise, such as an ERP system 32. Consequently, when sensor data is received at an RFID data router 28, application level logic 23 may analyze the received sensor data, and act upon the data based on its relation to enterprise data stored locally at the RFID data router 28. In contrast to prior art systems, application level logic (e.g., data processing rules) and enterprise data at the intelligent data router may be dynamically configured, reconfigured and/or updated in real-time, without compiling or re-compiling code or instructions. Moreover, an application programming interface facilitates the easy integration of third party application level logic 57, which may be configured by, and integrated to work with, third party applications 27. Accordingly, an application programming interface 45 may be defined and implemented to facilitate the exchange of data between third party application level logic 57 and nodes of the extended enterprise.

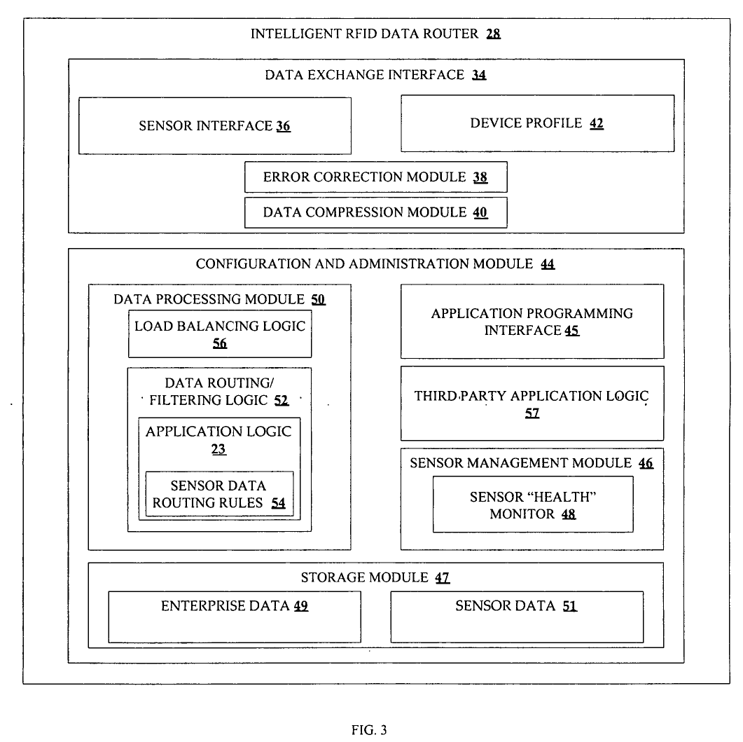

FIG. 3 illustrates an intelligent RFID data router 28 according to one embodiment of the invention. As illustrated in FIG. 3, the RFID data router 28 includes a data exchange interface 34 to communicatively couple the RFID data router 28 to various network nodes or devices, including (but not necessarily limited to), an enterprise data management server 26, and/or an enterprise resource planning (ERP) system 32. In one embodiment of the invention, the data exchange interface 34 may include a sensor interface 36 for communicatively coupling the RFID data router 28 to one or more heterogeneous types of sensor devices. For example, the sensor interface 36 may utilize standard or proprietary communication protocols for facilitating bi-directional communications with one or more data sensors. In one embodiment of the invention, the sensor interface 36 works in conjunction with the data exchange interface 34. However, in an alternative embodiment, the sensor interface 36 may provide a separate and distinct interface to one or more sensor devices. Accordingly, in one embodiment of the invention, the sensor interface 36 may communicate with one or more sensor devices utilizing a communication protocol that is different from the communication and network protocols used by the data exchange interface 34. In addition, either the data exchange interface 34 or the sensor interface 36 may include a radio frequency transceiver and the necessary wireless networking protocols to facilitate wireless communications with one or more data sensors with wireless networking capabilities. In one embodiment of the invention, because the RFID data router 28 utilizes standard communication and network protocols, the RFID data router 28 can be easily integrated into an enterprise's existing network.

It will be appreciated that in various embodiments, the RFID data router 28 may be implemented to include any number and type of physical ports for connecting to and communicating with data sensors. For example, in one embodiment of the invention, the RFID data router 28 may include several of the same type of standard physical port, such as a fixed number of RJ-45 ports. Alternatively, in one embodiment of the invention, the RFID data router 28 may be implemented to include a variety of physical ports, including, but not limited to one or more of the following: RJ-45 port, RS232 serial port, or RS422 serial port. Generally, the number and type of physical ports included will be dependent upon the particular application for which the RFID data router 28 is deployed. In addition, numerous sensor devices may be supported by any number of virtual ports configured for wireless communications.

As illustrated in FIG. 3, the data exchange interface 34 of the RFID data router 28 also includes error correction logic 38 and data compression logic 40. In one embodiment of the invention, the error correction logic 38 includes a number of algorithms for data verification and/or error detection. For example, in one embodiment of the invention, when an RFID data router 28 receives data from a sensor device, the RFID data router 28 may verify the data using an error detection algorithm. If the data received from the sensor device is found to be corrupt, for example, because of line noise or RF interference in the environment, the error correction logic 38 is able to detect the corrupt data. Moreover, one embodiment of the RFID data router 28 may include the capability to correct errors. For example, the error correction logic of the RFID data router 28 may notify the data sensor of the corrupt data and request that the data sensor resend the data. Because error correction occurs at the network edge, other application and network layers are not impacted when errors occur and they do not have to expend any additional processing power or bandwidth dealing with corrupt data.

In addition, the data compression logic 40 of the data exchange interface 34 provides a mechanism for encoding and decoding data to reduce bandwidth requirements. Accordingly, in one embodiment of the invention, each RFID data router 28 shares an encoding/decoding algorithm with one or more sensor devices and/or the enterprise data management server 26, thus enhancing the volume of data that can be transported without significant investments to increase bandwidth.

In one embodiment of the invention, the data exchange interface 34 may include one or more device profiles 42. For example, a device profile 42 may include configuration data (e.g., communication protocols, a device driver, device settings, sensing or reading schedules, etc.) to facilitate communication with a data sensor (e.g., an RFID reader). For example, in one embodiment of the invention, a device profile may include configuration data for automatically configuring the configuration parameters of a sensor device with plug-and-play capabilities. Accordingly, in one embodiment of the invention, the RFID data router 28 may automatically detect when a new data sensor is present and perform a self-configuration routine. In addition, upon detection of a new data sensor, the RFID data router 28 may automatically alert the enterprise data management server 26. Accordingly, the enterprise data management server 26 may automatically perform a self-configuration routine to establish a connection with the new data sensors. Alternatively, the enterprise data management server 26 may notify a system administrator of the detected sensor device so further configuration routines may be completed. As described in greater detail below, one embodiment of an RFID data router 28 includes a configuration and administration module 44 that allows the RFID data router 28 to be remotely administered and configured, including remote installation of device profiles, including device drivers for sensor devices. Accordingly, the enterprise data management server 26 may communicate configuration data to one or more RFID data routers 28 to configure the configuration parameters of an RFID data router.

In one embodiment of the invention, the RFID data router 28 may include support for a wide variety and type of data sensors. Consequently, in one embodiment of the invention, the RFID data router 28 supports software and/or firmware upgradeability. For example, device profiles for data sensors may be stored at and managed from the enterprise data management server 26. Accordingly, device profiles including software upgrades may be distributed to data sensors and RFID data routers 28 from a centralized location.

Referring again to FIG. 3, in one embodiment of the invention, the RFID data router 28 may include an administration and configuration module 44. The administration and configuration module 44 may include a web server component(not shown) that facilitates remote configuration of the RFID data router 28 from a traditional web browser application. For example, the configuration and administration module 44 may include a number of administration and configuration Internet documents (e.g., web pages) that serve as an administrative interface to the various configuration settings for the RFID data router 28, and/or data sensors. Accordingly, each RFID data router 28 and each data sensor 24 in the sensor network may be configured and administered remotely from a conventional web browser application.

The configuration module 44 of the RFID data router 28 illustrated in FIG. 3 also has a sensor management module 46. In one embodiment of the invention, the sensor management module 46 serves as a translation layer between the enterprise data management server 26 and various data sensors 24. For example, the sensor management module 46 may receive a command from the enterprise data management server 26, translate the command to a format the sensor device 24 will recognize, and then communicate the command to the sensor device 24. In addition, the sensor management module 46 may control the frequency with which read commands are communicated to individual sensor devices 24, such as RFID readers. For example, the sensor management module 46 may receive configuration information from the enterprise data management server 26 including an RFID reader schedule indicating when each sensor should perform a read operation. Accordingly, the RFID data router 28 may communicate read commands to each of the RFID readers according to scheduling information received from the enterprise data management server 26, or directly from a business application, such as an ERP module. Alternatively, if the RFID reader supports it, the RFID data router 28 may communicate the entire schedule to the RFID reader 24.

In addition, the sensor management module 46 may include a sensor “health” monitor 48. In one embodiment of the invention, the sensor “health” monitor periodically polls each sensor device 24 to determine whether each sensor device 24 is functioning properly. If, for example, a sensor device malfunctions and does not properly respond when polled, the sensor “health” monitor 48 may detect the malfunction and automatically communicate a notification message directly to a system administrator, or alternatively, via the enterprise data management server 26. Additionally, the sensor “health” monitor 48 may include fail-over procedures in the case that a sensor device 24 fails. For example, if the sensor “health” monitor 48 detects that a sensor device 24 has malfunctioned, the sensor “health” monitor 48 may attempt to activate another sensor device 24 to perform the operations of the sensor device that has failed.

In one embodiment of the invention, the RFID data router 28 includes support for grouping different sensor devices 24 into zones, for example, by location or by function. For example, the sensor management module 46 of the data router 28 may receive zone configuration information from the enterprise data management server 26 defining a particular zone as a certain group of sensor devices 24. Accordingly, zone configuration information may be maintained at two levels—at the enterprise data management server 26 and at the RFID data router 28. A zone may be defined to cover a particular physical location, or alternatively, a zone may be defined according to some other attribute, for example, sensor capabilities, or data being sensed. All of the data sensors making up a particular zone may be associated with, and communicatively coupled to, the same RFID data router 28, or alternatively, a zone may incorporate a group of sensor devices 24 that are associated with, and communicatively coupled to, different RFID data routers 28. In any case, once a zone has been defined, commands may be directed to a zone. For example, a business application may schedule a read command for all sensors in a particular zone on a predetermined time interval. Alternatively, an application user, or system administrator, may issue a read command to all the sensors in a zone in real-time.

In one embodiment of the invention, the RFID data router may include an application programming interface (API) to facilitate integration with ERP and/or third party software applications. For example, utilizing a common set of commands and data structures, complex business rules may be encapsulated in third party application level logic that is integrated into the overall system architecture and executed by one or more RFID data routers 28.

Again referring to FIG. 3, in one embodiment of the invention, the RFID data router 28 includes a data processing module 50. In one embodiment, the data processing module 50 performs a variety of processing tasks, including but not limited to: data analysis, data filtering, data forwarding, and load balancing. For example, in one embodiment of the invention, the data processing module 50 receives sensor data from each of the connected data sensors 24. The data processing module 50 may analyze the data, for example, by processing the data in accordance with application level logic 23. Accordingly, sensor data may be processed against one or more sensor data processing rules 54. Depending on the data and the sensor data processing rule 54, the data may be forwarded directly to one or more applications, such as ERP application modules, or to a data management module or storage module 47 where the data may be stored. Moreover, if the sensor data does not satisfy any-conditions expressed in a sensor data processing rule 54, the sensor data may be dropped, or ignored, such that no action is taken.

In traditional RFID systems, RFID readers might be considered “dumb” devices that simply capture data and communicate the data to a server for processing. One of the advantages of the present invention is that the intelligent RFID data router 28 provides a mechanism for executing application level logic 23 or business rules (e.g., sensor data processing rules 54) at the network edge. Accordingly, data that is received from RFID readers and other data sensors can be filtered according to complex business rules generated at the application level, and only data that is important to a particular application will be sent over the network. Not only does this provide a way to reduce unwanted network traffic, it also provides intelligent, real-time routing capabilities. For example, the RFID data processing module 50 provides a mechanism for making intelligent data routing decisions. Complex business rules may be encapsulated in sensor data processing rules 54. Accordingly, the data routing/filtering logic 52 of the processing module may, in accordance with a particular processing rule 54, route data directly to a node on the network for further processing.

In one embodiment of the invention, the sensor data processing rules 54 of the application level logic 23 may be dependent or conditioned upon enterprise data 49. For example, a sensor data routing rule may indicate that data matching some enterprise data be forwarded, along with the enterprise data to another application or another RFID data router 28. Accordingly, the application level logic 23 may utilize application or enterprise data 49 stored in a storage module 47 at the RFID data router 28. The enterprise data 49 may be independent of any ERP system stored data. Alternatively, the enterprise data 49 may be dynamically linked to ERP system stored data such that ERP data modified by an ERP application results in an automatic update of the ERP data stored at the RFID data router 28.

The sensor data processing rules 54 of the application level logic 23 may also be dependent or conditioned upon previously received and stored sensor data 51. Accordingly, as data is received from a sensor, a data processing rule 54 may compare the received data, or analyze the received data, in light of previously received sensor data. In this way, sensor data rules 54 can be configured to analyze data patterns. Accordingly, notifications and alerts may be developed and implemented with data processing rules 54. The notifications and alerts may be conditioned upon receiving particular data, or patterns of data.

The storage module 47 provides the data processing module 50 of the RFID data router 28 with significant capabilities. In particular, the application level logic 23 executing at the RFID router 28 need not query an external data source, or retrieve data from an external data source, in order to make an intelligent decision on how to process sensor data received from a sensor. Instead the application level logic 23 is free to utilize enterprise data stored at the RFID data router when processing sensor data. Consequently, as events occur and data is collected in other locations, such data may be forwarded to a remote RFID data router for storage and use with one or more applications by way of a sensor data processing rule 54. For example, in the context of a supply chain management system, order information received by phone or via the Internet may be automatically communicated to the enterprise edge (e.g., an RFID data router). Accordingly, as events associated with the order occur, data captured at the network edge can be associated with the order, and alerts and notifications can be communicated to interested parties (e.g., the customer, third parties, etc.)

In one embodiment of the invention, RFID related business rules are encapsulated in sensor data routing rules, and defined, based in part, on the following RFID events:
New RFID tag identified—this event occurs when a particular RFID tag is identified for the first time by a particular RFID reader, or zone (e.g., group of readers).
RFID tag location changed—this event occurs when a previously identified RFID tag is identified by a new RFID reader, or zone of readers.
RFID tag lost—this event occurs when an RFID tag previously identified by a particular reader, or zone, is not identified in a successive read operation.

Accordingly, complex business rules may be defined at the application level using the above RFID events in combination with any number of other attributes. For example, an ERP application may define a rule so that all RFID data associated with a particular type of asset read from a certain zone (e.g., group of readers) is directly routed to a particular node of the network. As will be described in detail below, the enterprise data management server 26 may process the rule and distribute it to one or more RFID data routers 28. Accordingly, when sensor data satisfying the rule is read at an RFID sensor 24 connected to an RFID data router 28 executing the rule, the data will be forwarded to the proper node for processing.

Referring again to FIG. 3, another aspect of the data processing module 50 is load balancing logic 56. In one embodiment of the invention, each RFID data router 28 includes load balancing logic 56 capable of monitoring the processing load of various nodes of the extended enterprise (e.g., ERP applications and third party applications), including the load level at other RFID data routers. Accordingly, the RFID data router 28 may be configured to make intelligent data routing and/or data processing decisions based on the load status of various extended enterprise nodes. For example, in a distributed computing environment where several servers are configured to balance a particular processing load, an RFID data router 28 may facilitate outbound load balancing by forwarding sensor data to the extended enterprise node that is least burdened in terms of load level.

Similarly, in the context of inbound loads, when several RFID data routers 28 are capable of communicating with, and receiving sensor data from, a plurality of sensor devices, the RFID data routers may attempt to balance the inbound data processing by sharing the load equally. Accordingly, the load balancing logic 56 may facilitate the automatic reconfiguration of communication sessions between sensor devices and data routers 28, for example, when one sensor device is capable of being communicatively coupled to send and receive data to/from more than one data router 28, for example, over a wireless connection. For example, in one embodiment of the invention, all of the RFID data routers 28 deployed in a particular location may communicate with one another to form a peer-to-peer network of routers. Accordingly, when one RFID data router experiences an abnormally high volume of incoming data from data sensors, the overloaded RFID data router 28 can communicate a message to another RFID data router, and request that the other RFID data router share in the processing of the incoming data. In this manner, the peer-to-peer network of RFID data routers 28 may automatically adjust to balance incoming loads. In one embodiment, this occurs by automatically and dynamically reconfiguring communication connections or sessions between various sensor devices and data routers. Alternatively, in one embodiment, each RFID data router 28 may be configurable to process incoming and outgoing data based on a priority level associated with the sensor data or data type. Accordingly, when incoming load levels exceed a predetermined threshold, a data router may filter the incoming data so that the sensor data assigned the highest priority is processed. In addition, if a particular data router 28 fails, a fail-over procedure may be initiated to replace the failing or failed RFID data router 28. For example, when the data management server 26 recognizes that an RFID data router 28 has failed, the data management server 26 may reallocate an existing “healthy” RFID data router 28 to replace a portion of, or all of, the application processing previously done by the failed RFID data router 28.

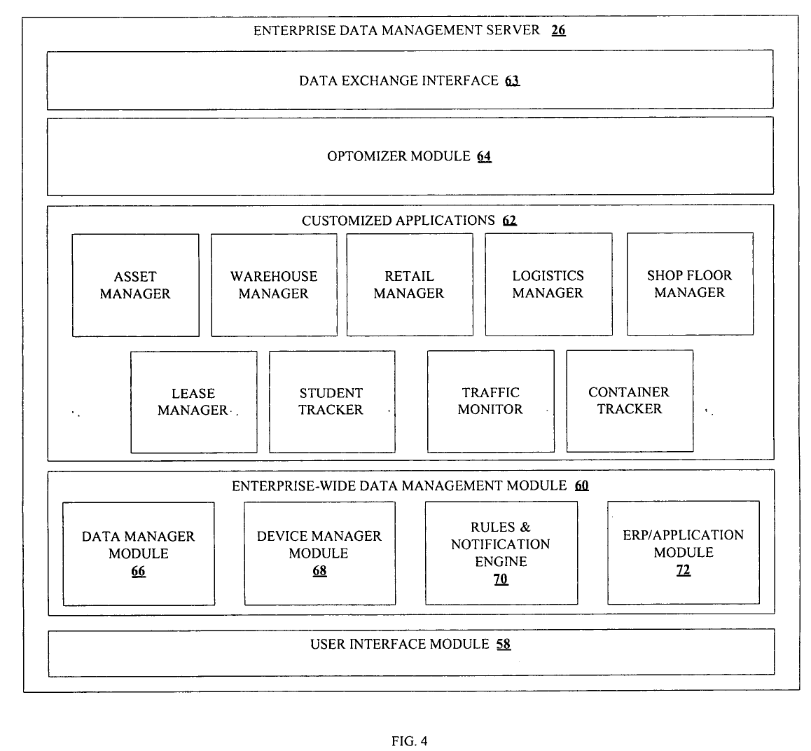

FIG. 4 illustrates an enterprise data management server 26 according to one embodiment of the invention. As illustrated in FIG. 4, in addition to a user interface component 58 and a data exchange interface 63, the enterprise data management server 26 includes three primary components—an enterprise-wide data management module (management module) 60, a group of customized application modules 62, and an optimizer module 64. In one embodiment of the invention, the management module 60 includes a data manager module 66, a device manager module 68, a rules and notification engine 70, an ERP/application module 72.

In one embodiment of the invention, the data manager module 66 provides a variety of functions, including, but not limited to: data definitions, data mappings, default data storage locations, etc. For example, in one embodiment of the invention, the data manager module 66 may include a number of data definitions. A data definition may, for example, provide a shared vocabulary for RFID data utilized in the system, and may make it possible for different applications to use rules based on the shared vocabularies. In addition, a data map may provide a mapping of RFID tag data to a variety of physical objects. Furthermore, in one embodiment of the invention, the management module may provide the option of capturing and storing all raw data. Accordingly, the data manager module 66 may provide configuration options to facilitate the storage of all the raw data. For example, the data manager module 66 may provide an interface to a system administrator for specifying one or more default data storage locations.

Referring again to FIG. 4, the management module 60 also includes a device manager module 68. The device manager module 68 provides a mechanism for managing all of the RFID data routers 28 and sensor devices 26 in the sensor network. For example, the device manager module 68 may utilize a user interface to facilitate remotely administering and configuring any RFID data routers 28 and/or data sensors 24 attached to the network. In one embodiment of the invention, the device manager module 68 includes a standard web interface making it possible to administer and configure various sensor devices 24 from any client device with a suitable web browser application. In addition, the device manager module 68 may include auto detection capabilities for RFID data routers 28 and sensor devices 24. Accordingly, when an additional RFID data router 28 is connected to the network, the device manager module 68 may automatically detect it. In one embodiment, the device manager module 68 may communicate a series of commands to the RFID data router 28 to automatically configure the RFID data router 28 according to a predetermined configuration setting stored in the device manager module 68. Alternatively, the device manager module 68 may generate an alert or communicate a message (e.g., email) to a system administrator to notify the administrator of the new RFID data router 28 and prompt the administrator to complete configuration of the device.

In one embodiment of the invention, the ERP/application module 72 of the management module 60 provides seamless integration of ERP business applications and other applications. For example, utilizing the ERP/application module 72, an application user has a real-time, bi-directional interface to the sensor network directly from an application console. In contrast to traditional RFID systems, application integration includes the ability to manage RFID data in real-time, without data duplication and/or data importing.

In one embodiment of the invention, the management module 60 also includes a rules and notification engine 70. The rules and notification engine 70 provides a mechanism for application programmers and application users to generate complex business rules for processing sensor data. For example, in one embodiment of the invention, a user may generate a sensor data processing rule that embodies a complex business rule via an ERP application module 72. The rule may be verified by the rules engine 70 and forwarded to one or more RFID data routers 28 in the network. Accordingly, based on the processing rule, when sensor data is processed at an RFID data router 28 executing the rule, the RFID data router 28 may appropriately forward the data to the proper network node for processing in real-time.

According to one embodiment of the invention, the management module 60 may be tightly integrated with a variety of customized applications 62, such as those illustrated in FIG. 4. In addition to specific data definitions, customized applications 62 may include recommended, or sample, device configurations for RFID data routers and/or data sensors. For example, based on the particular application, the management module 60 may communicate a series of configuration commands to one or more RFID data routers 28, corresponding to a recommended device configuration file associated with a particular customized application 62. The configuration commands may include a reader schedule instructing the RFID data router 28 how frequently to issue read commands to a particular RFID reader or group of readers. In addition, the customized application may provide a complete solution for a particular industry or application. For example, a customized application 62 may include an entire suite of user interfaces and data management routines for managing sensor data in a particular setting.

Another advantage of the present invention is the optimizer module 64. As illustrated in FIG. 4, the enterprise data management server 26 includes an optimizer module 64. The optimizer module 64 may include any number of algorithms for utilizing sensor data to optimize a business process. For example, in the context of an ERP application, the optimizer module 64 may analyze the various inputs for a business transaction and notify a user of any inefficiency if one is detected. An optimization algorithm may also include an analysis of ERP data and sensor data.

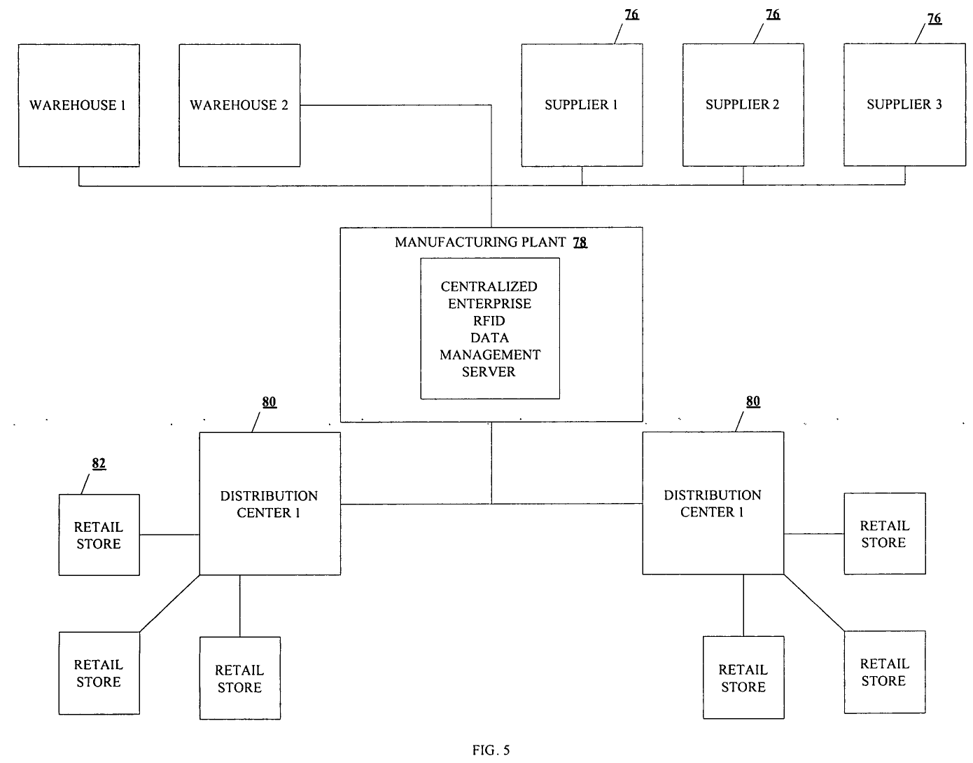

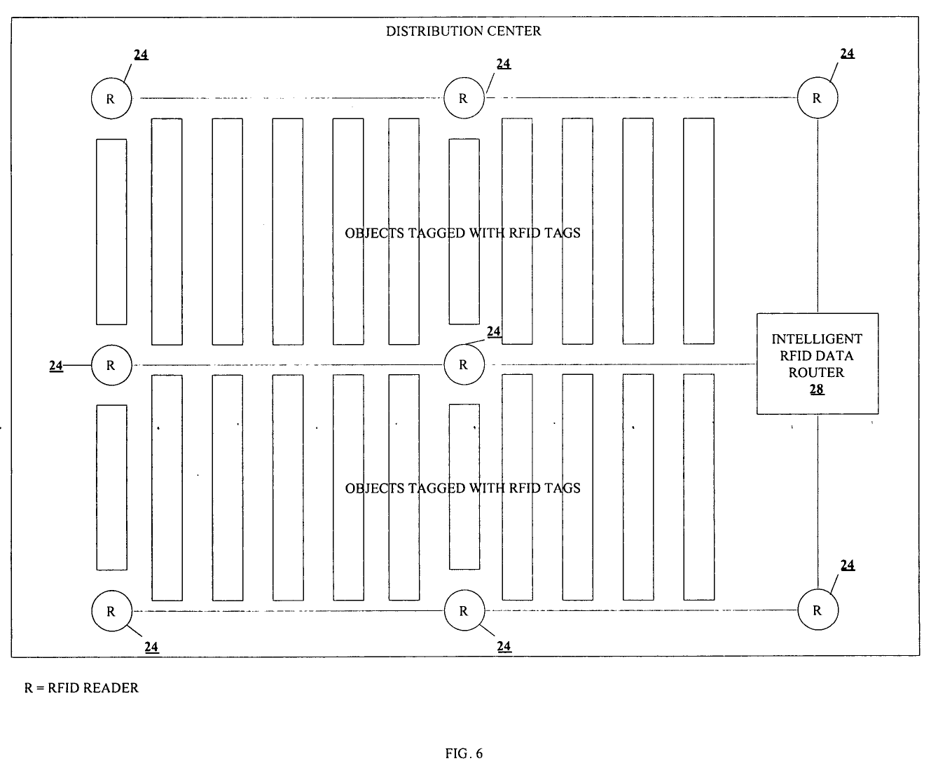

FIGS. 5 and 6 illustrate an enterprise wide view of an RFID system 74 consistent with one embodiment of the invention. FIG. 5 illustrates an example of the various locations in which the components of the present invention may be deployed. For example, the present invention may be used in a variety of applications tracking objects as they travel from a supplier 76, to a manufacturing plant 78, to a distribution center 80, to a retail store 82. In the example illustrated in FIG. 5, each location shown may include several data sensors connected to one or more RFID data routers 28. For example, as illustrated in FIG. 6, a network of RFID readers (R) is connected to a single RFID data router 28. Although in FIG. 5, the enterprise RFID data management server is shown as a centralized server located at the manufacturing plant, it will be appreciated that the enterprise data management server 26 could be in any location, or distributed across locations.

In one embodiment of the invention, the enterprise data management server 26 may be used to define zones, so that a group of data sensors (e.g., RFID readers) are configured to act as one. For example, in the example illustrated in FIG. 5, the enterprise may group all of the RFID readers in warehouse 1 and warehouse 2 together in one zone. Accordingly, an administrator may issue a read command to the entire zone from the manufacturing plant to take an instant inventory of parts stored in warehouse 1 and warehouse 2.

In one embodiment of the invention, the optimizer module 64 of the enterprise RFID data management server 26 may utilize RFID data to alert an administrator of inefficiencies in a business process. For example, referring to FIG. 5, an optimizer algorithm executing on the enterprise RFID data management server 26 may communicate a warning or alert to an administrator when, for example, there appears to be a particular shortage of a particular raw material used in a manufacturing process. Moreover, an optimizer algorithm may analyze the level of sales of certain products at various retail locations in an attempt to spot trends. Accordingly, if the analysis results in the identification of a particular trend, the optimizer module 64 may take several steps, including: alerting a system administrator of the trend, and/or ordering, or scheduling an order for, the raw materials used to manufacture the particular product that is selling well at the various retail locations.

Thus, methods and systems have been provided with reference to specific exemplary embodiments. It will be evident that various modifications and changes may be made to theses embodiments without departing from the broader spirit and scope of the invention. Accordingly, the specification and drawings are to be regarded in an illustrative rather than a restrictive sense.

What is claimed, is:

1. A data router, comprising:
a data exchange interface to communicatively couple the data router to a data management server and one or more data sensors, so as to facilitate receiving data from, and sending data to, the data management server and the one or more data sensors; and
a data processing module to execute application level logic, the application level logic implementing data processing rules for processing sensor data received, in real-time, from the one or more data sensors and.

2. The data router of claim 1, further comprising:
a storage module to, in real-time, receive and store enterprise data and sensor data, wherein the application level logic implementing data processing rules processes the enterprise data and/or sensor data stored in the storage module.

3. The data router of claim 1, wherein the data routing module includes load balancing logic to monitor load levels at extended enterprise nodes configured to receive sensor data from the data router, and to determine an extended enterprise node most qualified to receive sensor data, wherein the data routing module is to route sensor data to the extended enterprise node most qualified to receive sensor data, in accordance with the sensor data processing rules.

4. The data router of claim 1, wherein the load balancing logic is to communicate with one or more other data routers to automatically balance inbound sensor data processing operations associated with inbound sensor data equally across the one or more other data routers.

5. The data router of claim 1, wherein the data routing module includes load balancing logic to monitor load levels associated with incoming sensor data processing, and upon exceeding a predetermined load threshold, the load balancing logic is to shift data processing operations associated with the incoming load to a peer data router.

6. The data router of claim 1, wherein the sensor data is sensed by, and received from, the one or more data sensors, and the sensor data processing rules operate on the sensed data.

7. The data router of claim 1, further comprising:
a data sensor interface to facilitate, in cooperation with the data exchange interface, receiving data from, and sending data to, heterogeneous types of data sensors.

8. The data router of claim 1, further comprising:
a data sensor interface separate from the data exchange interface to communicatively couple the data router to one or more data sensors, so as to facilitate receiving data from, and sending data to, the one or more data sensors utilizing a network protocol that is different from the network protocol utilized by the data exchange interface.

9. The data router of claim 1, further comprising:
a data sensor management module to automatically configure one or more configuration parameters of a data sensor communicatively coupled to the data router, wherein the one or more configuration parameters of the data sensor control data sensing operations of the data sensor.

10. The data router of claim 9, wherein the data sensor management module is to receive configuration data from the data management server, and the configuration module is to utilize the configuration data received from the data management server to configure the one or more configuration parameters of the data sensor communicatively coupled to the data router.

11. The data router of claim 1, further comprising:
a data sensor management module to automatically detect the presence and type of a new data sensor, and to automatically configure the data exchange interface of the data router, based in part on the type of the new data sensor, to communicatively couple the data router to the new data sensor, so as to facilitate receiving data from, and sending data to, the new data sensor.

12. The data router of claim 11, further comprising:
a device profile module to store device profiles for data sensors, wherein the device profile module is to request a device profile from the data management server when the data sensor management module detects the presence of a new data sensor for which the device profile module is not storing a corresponding device profile.

13. The data router of claim 1, further comprising:
a data sensor management module to receive, from the data management server, a first command identifying a subset of data sensors communicatively coupled to the data router, the command instructing the data router to organize the subset of data sensors into a group, wherein the sensor management module, upon receiving a second command directed to the group, is to distribute the command to each data sensor in the group.

14. The data router of claim 1, further comprising:
a data sensor monitor to monitor the operations of the one or more data sensors, and to communicate an alert upon determining a data sensor is operating outside normal operational specifications.

15. The data router of claim 1, wherein the data exchange interface facilitates wireless and/or wired communication between the data router, the data management server and the one or more data sensors.

16. The data router of claim 1, further comprising:
data decompression logic to decompress sensor data received from a data sensor that compressed the sensor data prior to communicating the sensor data to the data router.

17. The data router of claim 1, further comprising:
error correction logic to detect and correct errors in data received at the data router.

18. A data management server, comprising:
a data exchange interface to communicatively couple a plurality of data routers to the data management server, so as to facilitate receiving data from, and sending data to, the plurality of data routers, and
a data router management module to communicate configuration data to the plurality of data routers, wherein each data router includes a data processing module to execute application level logic, the application level logic. implementing data processing rules for processing, in real-time, sensor data received from one or more data sensors communicatively coupled to a data router.

19. The data management server of claim 18, further comprising:
a data router management module to automatically detect the presence on the network of a new data router, and to automatically configure the data exchange interface of the data management server to communicatively couple the data management server to the new data router, so as to facilitate receiving data from, and sending data to, the new data router.

20. The data management server of claim 18, further comprising:
a data sensor management module to automatically detect the presence on the network of a new data sensor, and to automatically configure the data exchange interface of the data management server to communicatively couple the data management server to the new data sensor, so as to facilitate receiving data from, and sending data to, the new data sensor.

21. The data management server of claim 18, further comprising:
a data sensor management module to organize a plurality of data sensors into one or more user-defined groups, and to issue a command to a user-defined group of data sensors by distributing the command to all data routers to which a data sensor in the user-defined group of data sensors is attached.

22. The data management server of claim 21, wherein the data sensor management module is to issue a read command to the user-defined group of data sensors, wherein the read command is to instruct the user-defined group of data sensors to perform a read operation in real-time.

23. The data management server of claim 21, wherein the data sensor management module is to issue a read scheduling command to the user defined group of data sensors, wherein the read scheduling command is to instruct the data sensors to perform read operations according to a schedule indicated in the read scheduling command.

24. The data management server of claim 18, further comprising:
a rule engine to verify a rule received from a business application, and to generate a sensor data processing rule based on the rule received from the business application.

25. A data management system comprising:
a plurality of data routers, each data router communicatively coupled to one or more data sensors; and
a data management server communicatively coupled to the plurality of data routers, so as to receive data from, and send data to, the one or more data sensors and the plurality of data routers, wherein the data management server is to communicate sensor data processing rule to a particular data router, and the particular data router is to process sensor data received from the one or more data sensors in accordance with the sensor data processing rule.

26. The data management system of claim 25, wherein the data router includes load balancing logic to monitor load levels at extended enterprise nodes configured to receive sensor data from the plurality of data routers, and to determine a network node most qualified to receive sensor data, and the data router is to route sensor data to the extended enterprise node most qualified to receive sensor data, in accordance with a sensor data processing rule.

27. The data management system of claim 25, further comprising:
a user interface component to receive user instructions, wherein the data management server is to organize the one or more data sensors into a sensor group based on the user instructions, and the data management server is to distribute a command directed to the sensor group to all data routers to which a data sensor in the sensor group is attached.
